(19) United States
(12) Patent Application Publication
(10) Pub. No.: US 2003/0135594 A1
(43) Pub. Date: Jul. 17, 2003

(54) System and method for efficient distribution of multicastable services

(76) Inventors: Lin Xu, Lempaala (FI); Jarno Leinonen, Tampere (FI)

Correspondence Address: MORGAN & FINNEGAN, L.L.P., 345 Park Avenue, New York, NY, 10154-0053, US

(21) Appl. No.: 10/008,334

(22) Filed: Dec. 6, 2001

(51) Int. Cl. G06F 15/173

(52) U.S. Cl. 709/223

(57) ABSTRACT

An improved system and method for the delivery of multicastable services in a geographical area served, for example, by both a web of cells capable of providing multicast links and a web of cells capable of providing only unicast links.

### FIELD OF INVENTION

This invention relates to systems and methods for data distribution.

### BACKGROUND INFORMATION

In recent times there has been an increase in the number and variety of services available to mobile terminals. Such services include video news feeds, software downloads, music, and the like. There has also been an increase in the number of mobile terminals in use. As a result, both network operators and terminals users may become more interested in using network resources efficiently and cost effectively.

In certain geographical areas, terminals may be served by both a web of cells capable of providing multicast links and a web of cells providing only unicast links. The multicast-capable cells would be those which from a data link layer point of view can operate in a point-to-multipoint fashion, while the unicast-only cells would be those which from a data link layer point of view operate only in a point-to-point fashion. For example, in a certain geographical area the multicast-capable cells might be DVB-T (Digital Video Broadcast-Terrestrial) cells while the unicast-only cells might be UMTS (Universal Mobile Telecommunications Service) and/or GPRS (General Packet Radio Service) cells.

In such geographical areas, by properly employing both cell types, it may be possible to reap a multitude of benefits including but not limited to using network resources more efficiently and more cost effectively.

### SUMMARY OF THE INVENTION

According to embodiments of the present invention, there is provided an improved system and method for the delivery of multicastable services in a geographical area served, for example, by both a web of cells capable of providing multicast links and a web of cells capable of providing only unicast links.

### BRIEF DESCRIPTION OF THE INVENTION

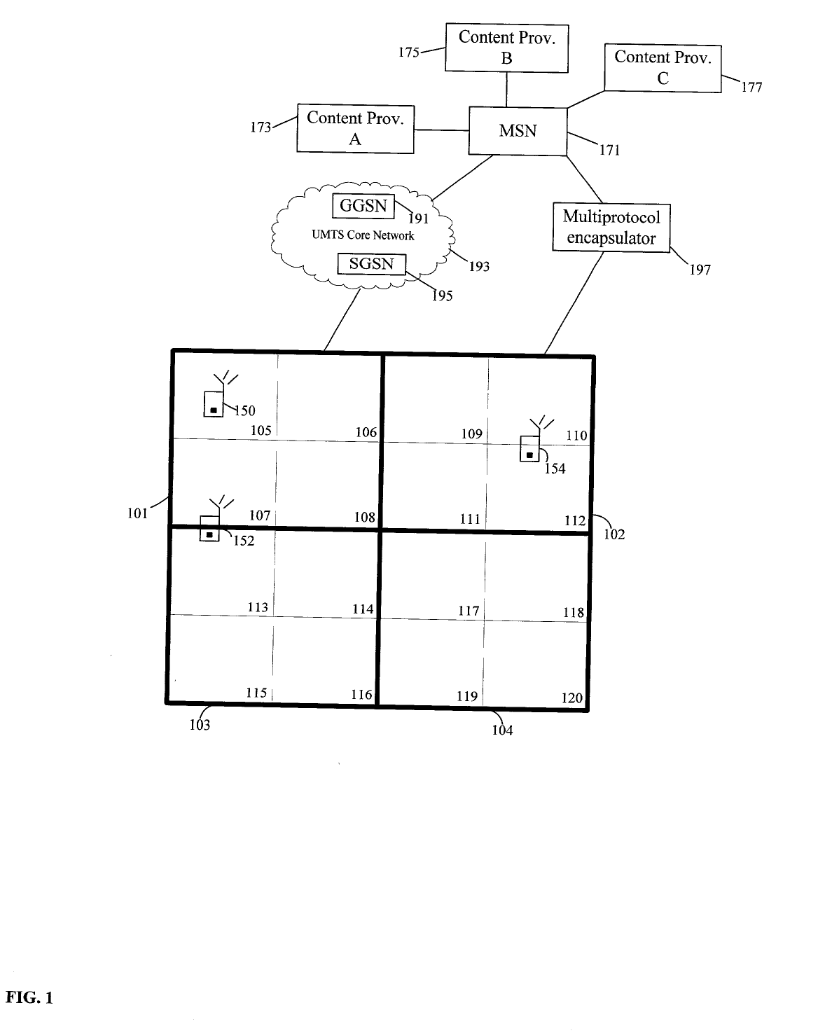

FIG. 1 shows an exemplary system and geographical area according to embodiments of the invention.

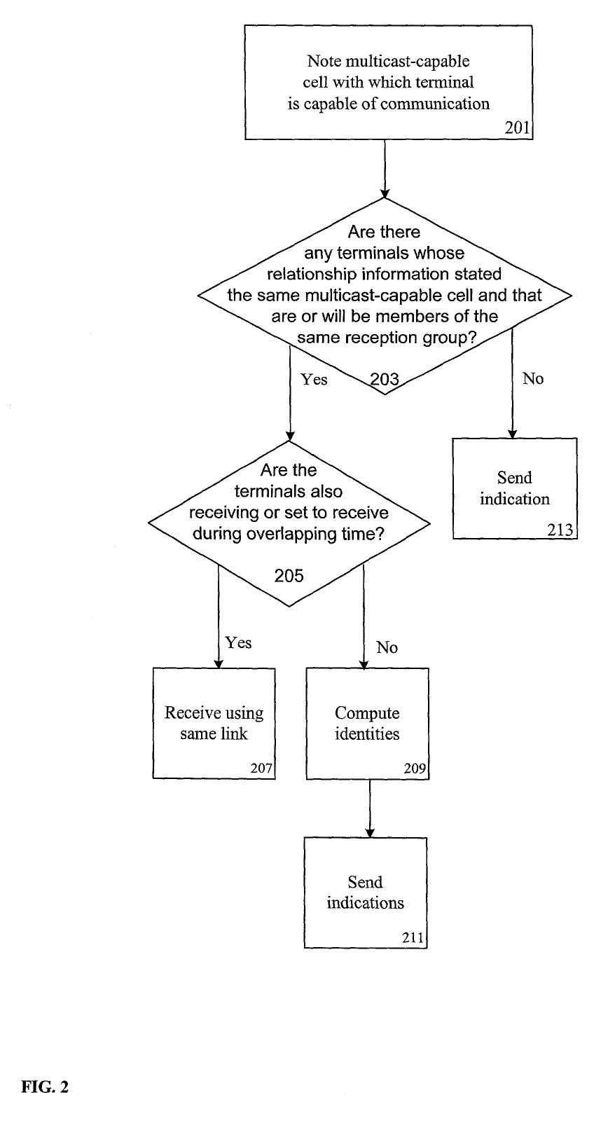

FIG. 2 is a flow chart showing the steps involved in making routing decisions according to embodiments of the invention.

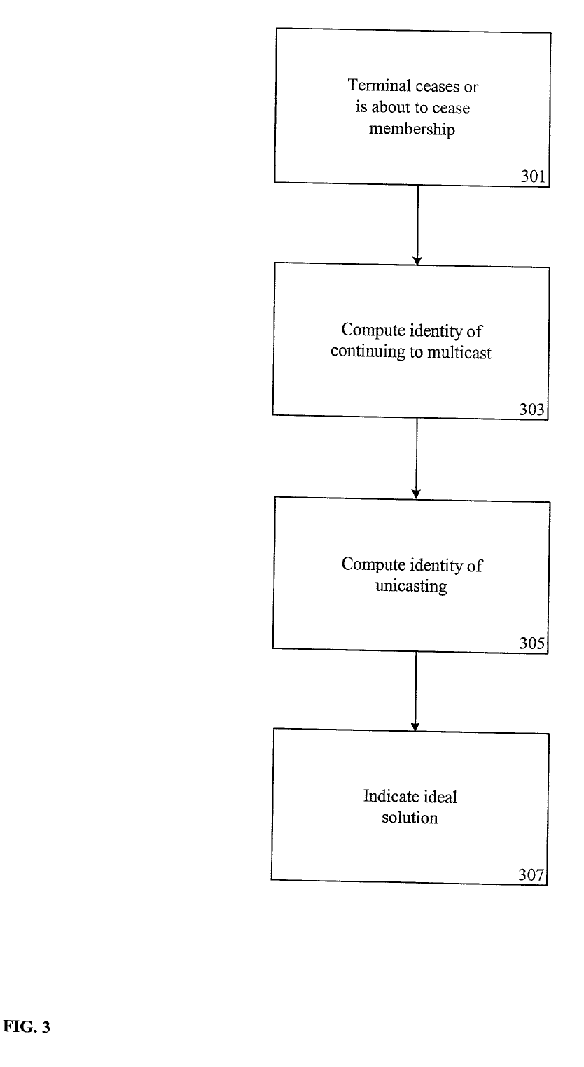

FIG. 3 is a flow chart showing additional steps involved in making routing decisions according to embodiments of the invention.

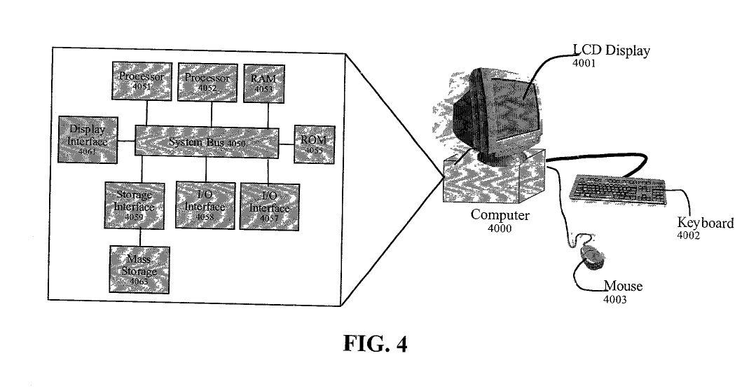

FIG. 4 shows an exemplary general purpose computer which may be used for performing certain aspects of the invention.

### DETAILED DESCRIPTION OF THE INVENTION

General Operation

Included in FIG. 1 is an exemplary geographical area served by two webs of cells providing wireless network service. Cells 101-104 represent cells of a first type capable of, from a data link layer point of view, providing multicast links while cells 105-120 represent cells of a second type that provides, from a data link layer point of view, only unicast links. Cells 101-104, for example, may provide DVB-T (Digital Video Broadcast-Terrestrial) service while cells 105-120 may provide GPRS (General Packet Radio Service) or UMTS (Universal Mobile Telecommunications Service) service. The two cell webs of this example provide overlapping service. Thus a mobile wireless terminal 150 might be able to receive service from at least one cell of the first type (e.g., cell 101) and from at least one cell of the second type (e.g., cell 105).

Continuing further with the example, suppose that multicastable services are available to this geographical area. An example of such a multicastable service would be a audiovisual program, such as a live news feed, that could be streamed either by unicast or by multicast. Such a program might, for example, be in either QuickTime format or Windows Media format. Another example could be a multicastable service that offered a download of ten popular video games. Terminals wishing to receive a particular service would join the corresponding reception group.

According embodiments of the present invention, it could be determined if it is most ideal to provide one or more terminals making up a subset of a particular reception group with the appropriate corresponding multicastable service via multicast using the link provided by a multicast capable cell or via unicast using the link provided by a unicast-only cell. It is noted that certain embodiments allow for the possibility that a multicastable service be provided via unicast using a link provided by a cell of the first type.

According to embodiments of the invention, such determinations can be made, for example, when a terminal joins a reception group and starts consumption of a multicastable service or when a terminal leaves a reception group and stops consumption of a multicastable service. Such a determination may also be made when a terminal changes its physical location such that there is a change in the cells that it has a relationship with, thereby changing the cellular distributions of the reception groups to which it belongs. As will be described in detail below, the determination of what choice is most ideal can take one or more of several factors into consideration.

Furthermore, certain embodiments additionally recognize the fact that a terminal may be in a physical location where it is capable of receiving service from more than one multicast-capable cell and/or more than one unicast-only cell. Each of the different possibilities for establishing a relationship between the terminal and a cell of each type corresponds to different potential cellular distributions of the reception groups to which the terminal belongs. Such embodiments allow for the selection of the cellular distribution found to be most ideal for each reception group.

According to embodiments of the present invention, there is provided one or more Multicast Support Nodes (“MSNs”). Each MSN is associated with one or more cells falling into one of two categories—multicast-capable and unicast-only. In one aspect, an MSN is responsible for receiving from a content provider the multicastable content relating to a particular reception group and making the decisions alluded to above concerning the most ideal way to forward it to subsets of that reception group, each subset consisting of one or more terminals.

A content provider may send to an MSN, via the Internet for example, multicastable service data relating to a particular reception group by directing it to a particular IP address. In some embodiments this may be a multicast IP address. Based on the decisions made, the MSN could maintain one or more routing tables that specify how particular multicastable services should be delivered to various reception group subsets. The MSN could change the tables in the case where it reevaluates the most ideal way to perform delivery.

For example, an MSN might initially determine that UMTS unicast is the best way to distribute, to a reception group subset consisting of three terminals, the multicastable service corresponding to a particular reception group. Under such circumstances the routing tables might include the specification that the service and/or packets relating thereto should be forwarded over the UMTS network to the three IP addresses corresponding respectively to each of the three terminals.

Suppose that at a later time a fourth terminal joins the reception group. As a result, the MSN might decide that the service should be distributed to the reception group subset consisting of the four terminals via DVB-T multicast using the link provided by a DVB-T cell with which the terminals have a relationship. Under such circumstances the routing tables might change to include the specification that the service and/or packets relating thereto should be forwarded via multicast over the DVB-T network to a particular multicast IP address. As is known in the art, forwarding over the UMTS network may involve interfacing with a GGSN (Gateway GPRS Support Node), while forwarding over the DVB-T network may involve interfacing with a multiprotocol encapsulator that encapsulates IP packets within DVB packets.

Referring again to exemplary FIG. 1, MSN 171 is associated with multicast-capable cells 101-104 and unicast-only cells 105-120. For this example, cells 101-104 may be DVB-T cells while cells 105-120 may be UMTS cells. In other embodiments the cells might support different standards. For example, cells 105-120 might be GPRS cells.

In FIG. 1, MSN 171 is operatively connected to content providers 173, 175, and 177. According to embodiments of the invention, MSN 171 may periodically receive from the content providers notifications of upcoming and/or currently-available multicastable services receivable by particular reception groups. The MSN could pass these notifications on to one or more of its related cells for transmission to the terminals in communication with those cells. For example, the MSN might pass these notifications onto DVB-T cells 101-104 for multicast transmission to the terminals in communication with those cells. The notifications could be sent to the terminals, for example, by use of SAP (Service Announcement Protocol) and/or SDP (Service Description Protocol). In lieu of or in addition to this, the notifications could be posted on a server such as a web server connected to the internet. In such embodiments, a terminal might access the server via the internet connectivity provided by a UMTS cell.

The user of terminal 150, learning of one of these multicastable transmissions, might decide the she wishes to receive it by joining the appropriate reception group. The user might specify this indication using a graphical user interface associated with her terminal. In response, the terminal 150 could indicate to the MSN 171 the user's desire to join the appropriate reception group. The terminal might do this, for example, using IGMP (Internet Group Management Protocol) via the connectivity provided by the UMTS cell with which it is associated. The indication might additionally specify a start time, stop time, and/or duration for membership. For example, the user might specify that she wanted to join the appropriate reception group so as to receive a constantly-available video news feed for a 15 minute period starting at 7 p.m. that day. Alternately, the user might specify that she wished to receive the video feed for a 15 minute period starting immediately or as soon as possible. In certain embodiments, the indication may additionally include information regarding the types of network interfaces that the terminal is equipped with and/or the cell types or networks that it is currently able to use. For example, a terminal might specify that is equipped with both DVB-T and UMTS interfaces, and that while DVB-T service is currently available to it, it is currently out of the UMTS coverage area.

A terminal that has requested to join a reception group will provide relationship information to the appropriate MSN. According to embodiments of the invention, this relationship information could include a specification of a multicast-capable cell, such as a DVB-T cell, and a unicast-only cell, such as a UMTS or GPRS cell, with which the requesting terminal is capable of communications. In certain embodiments, the requesting terminal could automatically provide the relationship information to the MSN at a time close to the specified start time. In other embodiments, upon receipt of the indication of the user's desire to join a particular reception group, the MSN could note from the supplied relationship information the specified start time. At a point in time close to the specified start time, the MSN could ask the terminal for the relationship information. In certain embodiments, the MSN could store received relationship information in a database or other store upon receipt. Furthermore, in some embodiments the MSN, upon receipt of the join request, could perform functions such as interfacing with a billing system or checking the user's eligibility to join the requested reception group. For example, the MSN might check parental block settings residing in an associated store if the user is a minor.

Once the MSN has made then forwarding decision, it will provide the appropriate terminals with the information necessary in order to receive the requested service. For example, in the case where the MSN decides that the service corresponding to the appropriate reception group will be forwarded via multicast (data link layer point-to-multipoint) over a DVB-T link, the MSN could tell the terminals to make sure that they are communicating with the appropriate DVB-T cell at event start time and that they listen for packets whose headers contain a specified multicast IP address. As another example, in the case where the MSN decides that the content will be forwarded via unicast (data link layer point-to-point) over an UMTS link, the MSN could tell the terminals to make sure that they have their PDP (Packet Data Protocol) contexts activated by event start time. The MSN could, for example, provide this information to the terminal using an UMTS link.

As alluded to above, and as will be explained below, there are several conditions under which an MSN may act to decide how to forward a service corresponding to a particular reception group to terminals belonging to that reception group. After making the forwarding decision the MSN could store information relating to the decision.

For example, upon the above-mentioned receipt of a terminal's request to join a particular reception group, the MSN may act to decide not only how the requesting terminal should receive the service, but also if the other terminals belonging to the reception group, or a subset thereof, should receive it in a new way

For example, the other terminals might have been initially told to receive unicast via the appropriate UMTS cell. However, responsive to the join request, the MSN might decide that those other terminals should switch to reception via DVB-T multicast like the requesting terminal.

As another example, the MSN may make the decision concerning forwarding of a service when a terminal leaves or requests to leave a reception group. As noted above, a requesting terminal might specify a stop time or membership duration. Alternately, a user receiving a service might use her terminal to indicate to the MSN that she wishes to leave the reception group and stop reception. The terminal might forward this information to the MSN using the link provided by an UMTS cell or GPRS cell with which the terminal is associated. As will be explained in more detail below, according to embodiments of the invention, when a terminal leaves and/or requests to leave a reception group, the MSN could reevaluate most ideal way to provide the service to the terminals that make up the remaining subset of the reception group. Thus the MSN might determine that the terminals retaining membership with the reception group receive a new and/or updated specification of the necessary information in order to receive the service relating to that reception group.

As a third example, the MSN may make a decision concerning forwarding of a service when a terminal changes its physical location such that it has different relationships and/or potential relationships with cells, thereby changing the cellular distributions of the reception groups to which it belongs. The behavior of the MSN in response to each of these conditions will now be described in more detail, as will ways in which an MSN may calculate ideality.

MSN Response to Terminal Request to Join a Reception Group

As noted above, an MSN maintains a store of previously recorded relationship information relating to terminal requests to join reception groups, and a store of information relating to previous forwarding decisions.

Upon receipt of the relationship information corresponding to a terminal's request to join a particular reception group, an MSN could note the multicast-capable cell with which the terminal is capable of communication (step 201). The MSN could then consult the store noted above to learn if there are any terminals whose relationship information stated the same multicast-capable cell and that are or will be members of the same reception group (step 203).

If such terminals exist, and additionally are set to receive or are receiving the reception group's service via the multicast-capable cell during a period of time at least overlapping the same time period (step 205), according to certain embodiments the MSN could decide that the reception group subset consisting of the joining terminal should receive the reception group's service over the same multicast link as the subset consisting of the other terminals (step 207).

If such terminals exist, but are set to receive or are receiving, the reception group's service via their respective unicast-only links (step 205), the MSN could compute the ideality of multicasting the reception group's service to the subset consisting of the joining terminal and the other terminals over the link provided by the multicast-capable cell (step 209). The MSN could next compute the ideality of unicasting the service to the subset via its terminals' respective unicast-only links (step 209).

In the case where the multicast solution is found to me more ideal, the MSN would indicate this to each of the terminals (step 211). This could be done, for example, using the unicast-only link associated with each terminal. The indication could, for example, specify that each terminal should be ready, either immediately, at its requested start time, or at a time stipulated by the MSN, to receive data from its associated multicast-capable cell and that it should watch for packets whose headers include a specified IP multicast address.

In the case where the unicast solution is found to be more ideal, the MSN could indicate this to the requesting terminal (step 211). The indication could specify that the terminal be ready, either immediately, at its requested start time, or at a time stipulated by the MSN, to receive the transmission from its associated unicast-only cell. The indication could be sent using the unicast link associated with the terminal. No indication would be sent to the other terminals, and they would therefore proceed as previously advised by the MSN.

If no terminals were found to exist whose relationship information stated the same multicast-capable cell and that are or will be members of the same reception group as the joining terminal, an indication could be sent to the joining terminal specifying that the terminal be ready to, either immediately, at its requested start time, or at a time stipulated by the MSN, receive the transmission form its associated unicast-only cell (step 213). Again, no indication would be sent to the other terminals and they would therefore proceed as previously advised by the MSN.

MSN Response to a Terminal Leaving a Reception Group

As noted above, a terminal's request to join a reception group may include an indication of the time that the terminal wishes quit membership. A terminal might also send a cessation request during reception.

At or near to quit time, in the case when the reception group's service is ongoing and there is a reception group subset consisting of other terminals that wish to continue reception of the service, the MSN may perform certain tasks to ensure that the terminals making up that subset will receive the service in the most ideal way.

For example, suppose that there is a terminal that is part of a reception group subset that is receiving the reception group's service by multicast via a particular multicast-capable cell. Suppose now that the terminal ceases or is about to cease membership in the reception group (step 301). The MSN could compute the ideality of continuing to multicast the reception group's service to the reception group subset consisting of the remaining terminals over the link provide by the multicast-capable cell (step 303). The MSN could next compute the ideality of unicasting the service to the terminals making up the subset via their respective unicast cells. The details of this computation will be described in more detail below (step 305).

In the case where the multicast solution is found to be more ideal, no indication would be sent to the remaining terminals, and they would therefore continue to receive as previously advised by the appropriate MSN (step 307).

In the case where the unicast solution is found to be more ideal, the MSN could indicate this to the subset consisting of the remaining terminals. The indication could specify that each terminal of the subset, either immediately or at a specified time, switch to receiving the reception group's service via its associated unicast-only cell. The indication could be sent to each terminal via each terminal's associated unicast link, or alternately via the appropriate multicast link (step 307).

MSN Response to Change in a Terminal's Location During Reception Group Membership

During reception of a particular multicastable program, a terminal may change its physical location such that it changes the cells that it has a relationship with, thereby changing the cellular distributions of the reception groups to which it belongs. Under such circumstances, the MSN may perform certain tasks to ensure that the program continues to be delivered in the most ideal way.

For example, suppose that a terminal that is a member of a particular reception group changes is physical location during reception of the reception group's service such that it changes the multicast-capable cell with which it has a relationship.

With respect to the multicast-capable cell with which the relationship had been severed, the appropriate MSN might perform steps analogous to those described with reference to an MSN's response to a terminal leaving a reception group.

With respect to the multicast-capable cell with which a new relationship had been established, the appropriate MSN might perform steps analogous to those described with reference to an MSN's response to a terminal request to join a reception group.

Calculation of Ideality As alluded to above, under certain circumstances an MSN may calculate the ideality of a particular way of distributing the multicastable program corresponding to a reception group to a reception group subset consisting of one or more terminals.

One method of determining ideality might be based on spectrum efficiency of data delivery. The calculation of ideality takes into account bandwidth, total number of users and Spectrum efficiency factor of different access systems. Spectrum efficiency factor is derived from the amount of spectrum consumed for transferring data with normalized bit rate. The unit is Hz/(bit/s). The spectrum efficiency factor is access system type dependent and it is also affected by the network planning and some other network condition (e.g. traffic load) According to certain embodiments, the calculation of this view of ideality may use the following equation:

$$\frac{{n}_{1}}{{\sum }_{each\_link} {n}_{2} . spectrum\_cosumption}$$

Where,

n1 and n2 represent weighting factors which could be chosen based on, for example, network operator preference, network characteristics and/or historical data collected about network use.

Spectrum_Consumption represents the spectrum that will be consumed for transferring the multicasted data via a single link. It is calculated as:

Spectrum_consumption=Efficiency_factor (Hz/bps)* Bandwidth(bps)

Suppose an MSN was comparing two ways of delivering the multicastable service corresponding to a particular reception group to a reception group subset consisting of three terminals. Suppose the first way being considered was to use the multicast link provided by a particular multicast-capable cell, while the second way being considered was to distribute to each of the terminals via their respective unicast-only cells.

Suppose that when the unicast solution is used that 300 kb/sec of bandwidth is necessary to distribute the program to each terminal (900 kb/s total), whereas when a multicast solution is used a total of 300 kb/s is sufficient to distribute the program to all three terminals. Suppose further that the spectral efficiency factor of using the multicast-capable cell associated with the three terminals is 2.0. Next suppose that the spectral efficiency factor of using the unicast-only cell associated with the first terminal is 1.1, the spectral efficiency factor of using the unicast-only cell associated with the second terminal is 1.0, and the spectral efficiency factor of using the unicast-only cell associated with the third terminal is 1.2. Finally suppose the weighting factor for each case is 1.0. According to this example, the ideality for distributing via multicast is:

$$\frac{1}{1 \cdot 2.0 \cdot 300 k}$$

While the ideality for distributing via unicast is:

$$\frac{1}{1 * 1.1 * 300 k + 1 * 1.0 * 300 K + 1 * 1.2 * 300 k}$$

Therefore in this example distributing via multicast would be the more ideal choice.

According to certain embodiments, an additional method of determining ideality might take might take into account bandwidth or bandwidths used and the monetary cost of using the bandwidth or bandwidths. According to certain embodiments, the calculation of this view of ideality may use the following equation:

n₁·bandwidth·n₂·cost_per_unit_bandwidth

Where, as above, n1 and n2 represent weighting factors.

According to certain embodiments, a further additional method of determining ideality might characterize ideality in terms of how well a particular transmission would serve the needs of those meant to be served by the bandwidth used to make the transmission. As a first factor, the determination might take into account what percentage of the total bandwidth available on the link would be used by the transmission in question. As a second factor, the determination might take into account the percentage of the terminals that are able to use the bandwidth that would actually be served by the transmission. Accordingly, for certain embodiments, the calculation of this view of ideality may use the following equation:

$$\frac{{n}_{1} \cdot percentage\_bandwidth \_used}{{n}_{2} \cdot percentage\_terminals \_served}$$

Where, as above, n1 and n2 represent weighting factors.

Furthermore, other methods of determining ideality could, for example, be specified by a system designer, network operator, or network administrator.

According to certain embodiments of the invention, the MSN may compute ideality by using a single one of these or other views of ideality. Other embodiments could employ a weighted or unweighted average of two or more of these or other views of ideality.

Additional Operations

There may be instances where there are two or more cells of a particular type with which a terminal may establish a relationship. For example, a terminal's geographical location may be such that there may be two DVB-T cells and/or two UMTS cells with which service may be established. In exemplary FIG. 1 the physical location of terminal 152 allows it to receive service from either of two DVB-T cells (107 and 113), and the physical location of a terminal 154 allows it to receive service from either of two UMTS cells (110 and 112). As alluded to above, in certain embodiments of the invention the MSN may take advantage of such circumstances when determining the most ideal way to distribute the multicastable service relating to a reception group.

According to embodiments of the invention, relationship information sent by a terminal to an MSN can include a specification of more than one multicast capable cell (e.g., DVB-T cells) and/or more than one unicast-only cell (e.g., UMTS or GPRS cells) that a terminal requesting reception of a multicastable program is capable of communication with. Each of the different possibilities for establishing a relationship between the terminal and a cell of each type corresponds to different potential cellular distributions of the reception groups to which the terminal belongs. Upon receipt of such information, an MSN may act to decide which of the potential cellular distributions is most ideal. In cases where the terminal in question is only capable of maintaining a link with a single multicast-capable link at a time, and the terminal is, when the multicastable service is to be received, actively receiving another program via one of a plurality of multicast-capable cells that are available, the appropriate MSN would need to take this into account.

Suppose that a particular terminal is capable of maintaining links with multiple multicast-capable cells, and/or the terminal is not actively receiving another program via a multicast-capable link. Suppose further that the relationship information specifies a number of available multicast-capable and/or unicast-only cells. Under such circumstances, one way of the MSN deciding which cellular distribution is most ideal would be to perform the above-described operations relating to terminal request to join a reception group with relation to each possible cellular distribution. Under such circumstances the MSN could choose the cellular distribution that is most ideal and perform the above-described appropriate steps for reception group service forwarding to terminals.

In the case where the terminal is incapable of maintaining links with multiple cells of a particular type and is actively receiving one or more programs via a particular one of the available links, the MSN could additionally take into account when computing various idealities any potential loss of ideality caused by breaking the current link.

For example, when computed in isolation, forwarding the reception group's service via a multicast-capable link other than the multicast-capable link already in use might have higher ideality than sending it via the link already in use. However, when the calculation takes into account the loss in ideality that would occur by breaking the link, it might be found that there would be a net loss in ideality.

Hardware and Software

Certain aspects of the present invention may be executed by or with the help of a general purpose computer. For example, an MSN may be implemented as a general purpose computer equipped with network interfaces.

The phrases “general purpose computer,” “computer,” and the like, as used herein, refer but are not limited to an engineering workstation, PC, Macintosh, PDA, mobile terminal and the like running an operating system such as OS X, Linux, Darwin, Windows CE, Windows XP, Symbian OS, or the like, perhaps with support for Java. The phrases “General purpose computer,” “computer,” and the like also refer, but are not limited to, one or more processors operatively connected to one or more memory or storage units, wherein the memory or storage may contain data, algorithms, and/or program code, and the processor or processors may execute the program code and/or manipulate the program code, data, and/or algorithms. Accordingly, exemplary computer 4000 as shown in FIG. 4 includes system bus 4050 which operatively connects two processors 4051 and 4052, random access memory (RAM) 4053, read-only memory (ROM) 4055, input output (I/O) interfaces 4057 and 4058, storage interface 4059, and display interface 4061. Storage interface 4059 in turn connects to mass storage 4063. Each of I/O interfaces 4057 and 4058 may be an Ethernet, IEEE 1394, IEEE 802.11, or other interface such as is known in the art. Mass storage 4063 may be a hard drive, optical disk, or the like. Processors 4057 and 4058 may each be a commonly known processor such as an IBM or Motorola PowerPC or an Intel Pentium.

Computer 4000 as shown in this example also includes an LCD display unit 4001, a keyboard 4002 and a mouse 4003. In alternate embodiments, keyboard 4002 and/or mouse 4003 might be replaced with a pen interface. Computer 4000 may additionally include or be attached to card readers, DVD drives, or floppy disk drives whereby media containing program code may be inserted for the purpose of loading the code onto the computer. In accordance with the present invention, computer 4000 may be programmed using a language such as Java, Objective C, C, C#, or C++ according to methods known in the art to perform the operations described above.

It is noted that in certain embodiments the MSN could be implemented using a stand-alone router device programmed to perform the operations described above. The above described user terminal could be, for example, a portable device comprising an ARM or a StrongARM processor, an integrated touch-sensitive color screen with the ability to receive DVB-T transmissions and the ability to send and receive UMTS, GPRS, or other transmissions. The device could use an operating system such as Microsoft Windows CE or Symbian EPOC, perhaps with support for Java. Thus the terminal could also be programmed using a language such as Java, Objective C, C, C#, or C++ according to methods known in the art to perform the terminal operations described above.

Ramifications and Scope

Although the description above contains many specifics, these are merely provided to illustrate the invention and should not be construed as limitations of the invention's scope. Thus it will be apparent to those skilled in the art that various modifications and variations can be made in the system and processes of the present invention without departing from the spirit or scope of the invention.

What is claimed is:

1. A method for effectively using network resources, comprising:
forwarding to a reception group the service corresponding to said reception group; and
upon a change in the cellular distribution of the reception group, deciding whether a subset of said reception group should receive said service via a unicast link or via a multicast link.

2. A method for effectively using network resources, comprising:
forwarding to a reception group the service corresponding to said reception group; and
upon a change in the composition of the reception group, deciding whether a subset of said reception group should receive said service via a unicast link or via a multicast link.

3. A method for effectively using network resources, comprising:
forwarding to a reception group the service corresponding to said reception group;
selecting from among available cellular distributions for said reception group; and
deciding whether a subset of said reception group should receive said service via a unicast link or via a multicast link;
wherein said steps of selecting and deciding are performed upon a change in the physical location of a member of said group.

4. A method for effectively using network resources, comprising:
forwarding to a reception group the service corresponding to said reception group;
selecting from among available cellular distributions for said reception group; and
deciding whether a subset of said reception group should receive said service via unicast or via multicast;
wherein said steps of selecting and deciding are performed upon a change in the composition of the reception group.

5. A method for effectively using network resources, comprising:
forwarding to a reception group the service corresponding to said reception group; and
upon a change in the cellular distribution of the reception group, deciding whether a subset of said reception group should receive said service via a unicast link or via a multicast link,
wherein said step of deciding further comprises determining the ideality of each option.

6. A method for effectively using network resources, comprising:
forwarding to a reception group the service corresponding to said reception group; and
upon a change in the composition of the reception group, deciding whether a subset of said reception group should receive said service via a unicast link or via a multicast link,
wherein said step of deciding further comprises determining the ideality of each option.

7. A system for effectively using network resources, comprising:
a memory having program code stored therein; and
a processor operatively connected to said memory for carrying out instructions in accordance with said stored program code;
wherein said program code, when executed by said processor, causes said processor to perform the steps of:
forwarding to a reception group the service corresponding to said reception group; and
upon a change in the cellular distribution of the reception group, deciding whether a subset of said reception group should receive said service via a unicast link or via a multicast link.

8. A system for effectively using network resources, comprising:
a memory having program code stored therein; and
a processor operatively connected to said memory for carrying out instructions in accordance with said stored program code;
wherein said program code, when executed by said processor, causes said processor to perform the steps of:
forwarding to a reception group the service corresponding to said reception group; and
upon a change in the composition of the reception group, deciding whether a subset of said reception group should receive said service via a unicast link or via a multicast link.

9. A system for effectively using network resources, comprising:
a memory having program code stored therein; and
a processor operatively connected to said memory for carrying out instructions in accordance with said stored program code;
wherein said program code, when executed by said processor, causes said processor to perform the steps of:
forwarding to a reception group the service corresponding to said reception group;
selecting from among available cellular distributions for said reception group; and
deciding whether a subset of said reception group should receive said service via a unicast link or via a multicast link;
wherein said steps of selecting and deciding are performed upon a change in the physical location of a member of said group.

10. A system for effectively using network resources, comprising:
a memory having program code stored therein; and
a processor operatively connected to said memory for carrying out instructions in accordance with said stored program code;
wherein said program code, when executed by said processor, causes said processor to perform the steps of:
forwarding to a reception group the service corresponding to said reception group;
selecting from among available cellular distributions for said reception group; and
deciding whether a subset of said reception group should receive said service via a unicast link or via a multicast link;
wherein said steps of selecting and deciding are performed upon a change in the composition of the reception group.

11. A system for effectively using network resources, comprising:
a memory having program code stored therein; and
a processor operatively connected to said memory for carrying out instructions in accordance with said stored program code;
wherein said program code, when executed by said processor, causes said processor to perform the steps of:
forwarding to a reception group the service corresponding to said reception group; and
upon a change in the cellular distribution of the reception group, deciding whether a subset of said reception group should receive said service via a unicast link or via a multicast link,
wherein said step of deciding further comprises determining the ideality of each option.

12. A system for effectively using network resources, comprising:
a memory having program code stored therein; and
a processor operatively connected to said memory for carrying out instructions in accordance with said stored program code;
wherein said program code, when executed by said processor, causes said processor to perform the steps of:
forwarding to a reception group the service corresponding to said reception group; and
upon a change in the composition of the reception group, deciding whether a subset of said reception group should receive said service via a unicast link or via a multicast link,
wherein said step of deciding further comprises determining the ideality of each option.

13. A method as in any of claims 1-6, wherein said deciding takes into account the bandwidth used and the spectral spectrum efficiency factor of each access system.

14. A system as in any of claims 7-12, wherein said deciding takes into account the bandwidth used and the spectrum efficiency factor of each access system.

15. A method as in any of claims 1-6, wherein said deciding takes into account the bandwidth used and the per-unit-cost of that bandwidth.

16. A system as in any of claims 7-12, wherein said deciding takes into account the bandwidth used and the per-unit-cost of that bandwidth.

17. A method as in any of claims 1-6, wherein said deciding takes into account the percentage of total available link bandwidth used and the percentage of terminals using the link that would be served by using the bandwidth.

18. A system as in any of claims 7-12, wherein said deciding takes into account the percentage of total available link bandwidth used and the percentage of terminals using the link that would be served by using the bandwidth.

19. A method as in any of claims 1-6, further comprising receiving a join indication from a terminal.

20. A system as in any of claims 7-12, wherein said processor additionally performs the step of receiving a join indication from a terminal,

21. The method of claim 19, w herein said join indication comprises a specification of the terminal's network interfaces.

22. The method of claim 19, wherein said join indication comprises a specification of the networks currently available to the terminal.

23. The method of claim 19, wherein said join indication comprises a specification of a desired start time for reception of transmissions.

24. The method of claim 19, wherein said join indication comprises a specification of a desired stop time for ceasing reception of transmissions.

25. The system of claim 20, wherein said join indication comprises a specification of the terminal's network interfaces.

26. The system of claim 20, wherein said join indication comprises a specification of the networks currently available to the terminal.

27. The system of claim 20, wherein said join indication comprises a specification of a desired start time for reception of transmissions.

28. The system of claim 20, wherein said join indication comprises a specification of a desired stop time for ceasing reception of transmissions.
